(19) United States
(12) Patent Application Publication
(10) Pub. No.: US 2025/0241424 A1
(43) Pub. Date: Jul. 31, 2025

(54) NAIL STICKER, METHOD FOR PREPARING NAIL STICKER, AND NAIL STICKER SET COMPRISING NAIL STICKER

(71) Applicant: GLLUGA INC., Chungcheongnam-do (KR)

(72) Inventors: Jun Gil UM, Gyeonggi-do (KR); Jae Bak AHN, Chungcheongbuk-do (KR); Hyo Sub KIM, Incheon (KR)

(21) Appl. No.: 18/701,671

(22) PCT Filed: May 18, 2023
(86) PCT No.: PCT/KR2023/006766

§ 371 Date: Apr. 16, 2024

(30) Foreign Application Priority Data
May 20, 2022 (KR) 10-2022-0062246
Sep. 21, 2022 (KR) 10-2022-0119370

(51) Int. Cl. A45D 29/00

(52) U.S. Cl. CPC A45D 29/001

(57) ABSTRACT

The present invention relates to a nail sticker which is curable by ultraviolet ray and the lower surface of the nail sticker before being cured by the ultraviolet ray includes a curved surface that the center of the nail sticker is upwardly curved.

### TECHNICAL FIELD

The present invention relates to a nail sticker, a manufacturing method of the nail sticker, and a nail sticker set including the nail sticker.

### BACKGROUND ART

As one of the ways to express physical beauty pursued by humans, the beauty industry is being developed at an accelerating pace and is being subdivided simultaneously. Specifically, with the rapid expansion of the market since the 20th century, the beauty industry began to become popular among the ordinary people. In the beauty industry, nail art is an essential element of expressive art for a body regardless of age group and gender and has been rapidly developing in recent years.

Originally, the nail art is one of the ways for beautifully decorating the human body as a field of beauty art. A length, a shape, or a color of a nail has been expressed to reflect cultural changes and values of the times.

In the nail art, a nail sticker with a shape of a fingernail or toenail which is artificially manufactured is used by many people. In the past, the nail sticker was manufactured in a curved shape, like a fingernail or toenail shape, to be supplied to consumers. Such nail stickers are injection molded products and are supplied to consumers in a hardened state. However, each people has a different fingernail or toenail shape (in particular, a curvature radius) so that there is a problem in that it is difficult to closely adhere the nail sticker which already had a curved shape to the consumer's fingernail or toenail.

In order to solve this problem, a nail sticker including a ultraviolet curing material has recently been in the spotlight. Specifically, the nail sticker including the ultraviolet curing material has a flat lower surface and a user (consumer) deforms the nail sticker to fit their fingernails or toenails and then irradiates the ultraviolet ray to cure the nail stickers. Therefore, the user's fingernail or toenail and the nail sticker can be closely adhered so that the adhesive strength of the nail sticker is improved. Such a nail sticker is also referred to as a gel nail sticker.

In the meantime, due to various reasons, the thickness of the gel nail sticker may be large. For example, in the case of the gel nail sticker which further extends from the tip of the fingernail or toenail, excluding the part overlapping the fingernail or toenail due to the long length of the gel nail sticker, the thickness may be thick to maintain the shape. Further, the thickness of the gel nail sticker may be increased due to the cosmetic reasons, in addition to the above-mentioned reasons. When the gel nail sticker is thick, even though the user deforms the shape by applying a force to the gel nail sticker to fit the user's fingernail or toenail, the gel nail sticker easily returns to its original shape. Accordingly, it is difficult to fit the gel nail sticker to the user's fingernail or toenail.

Accordingly, a new technology is demanded to allow the user to effectively fit the gel nail sticker to the fingernail or toenail.

### RELATED ART DOCUMENT

### Patent Document

(Patent Document 1) Korean Unexamined Patent Application Publication No. 10-2019-0014044

### DISCLOSURE

### Technical Problem

An object to be achieved by the present disclosure is to provide a nail sticker which is easily molded by a user to be fitted to the user's nail (fingernail or toenail) shape.

Another object to be achieved by the present invention is to provide a manufacturing method of the nail sticker.

Still another object to be achieved by the present invention is to provide a nail sticker set including the nail sticker.

### Technical Solution

According to an exemplary embodiment of the present invention, in a UV curable nail sticker, a lower surface of the nail sticker before being cured by the ultraviolet ray includes a curved surface that the center of the nail sticker is upwardly curved.

According to another exemplary embodiment of the present invention, a manufacturing method of a nail sticker is provided. The manufacturing method of nail sticker includes a first step of placing a UV curable preliminary nail sticker on a support unit included in a support structure; and a second step of adhering a lower surface of the preliminary nail sticker to an upper surface of the support unit by applying a pressure to an upper surface of the preliminary nail sticker, and the support unit has a curved surface which is upwardly convex and a lower surface of the nail sticker before being cured by the ultraviolet ray includes a curved surface that a center of the nail sticker is upwardly curved.

According to still another exemplary embodiment of the present invention, a nail sticker set includes a support structure including a support unit; and a nail sticker attached on an upper surface of the support unit, the upper surface of the support unit includes a curved surface that the center of the sticker is upwardly curved, the nail sticker is curable by ultraviolet ray, and a lower surface of the nail sticker before being cured by the ultraviolet ray includes a curved surface that the center of the nail sticker is upwardly curved.

### Advantageous Effects

According to the present invention, as compared with the existing nail sticker with a flat lower surface, a lower surface of the nail sticker before being cured has a curved surface in which a center of the nail sticker is upwardly curved so that a user may easily mold the nail sticker to be fitted to the user's own nail shape. In a series of processes of attaching and curing the nail sticker by the user, the molded shape of the molded nail sticker may be maintained well so that the user may conveniently use the nail sticker and apply the nail sticker fitted to the user's nail.

### DESCRIPTION OF DRAWINGS

FIG. 1 is a diagram of a nail sticker according to an exemplary embodiment of the present invention.

FIG. 2 is a photograph of a nail sticker according to an exemplary embodiment of the present invention.

FIG. 3 is a top view of a nail sticker according to an exemplary embodiment of the present invention.

FIG. 4 is a cross-sectional view of a nail sticker taken along x-x′ of FIG. 3.

FIG. 5 is a cross-sectional view of a preliminary nail sticker before being placed on a support unit.

FIG. 6 is a diagram of a support unit mentioned in the specification.

FIG. 7 is a diagram for explaining a manufacturing method of a nail sticker according to another exemplary embodiment of the present invention.

FIG. 8 is a diagram for explaining a manufacturing method of a nail sticker according to another exemplary embodiment of the present invention.

FIG. 9 is a diagram for explaining a manufacturing method of a nail sticker according to another exemplary embodiment of the present invention.

FIG. 10 is a diagram of a nail sticker set according to an exemplary embodiment of the present invention.

FIG. 11 is a photograph of a nail sticker set according to an exemplary embodiment of the present invention.

FIG. 12 is a photograph of a nail sticker set according to an exemplary embodiment of the present invention.

FIG. 13 is a photograph of a nail sticker according to Example 1 of the present invention, and specifically, is a photograph immediately after removing the nail sticker manufactured by performing first to third steps of a manufacturing method of a nail sticker described in the present invention from a support unit.

FIG. 14 is a photograph of a nail sticker according to Example 1 of the present invention, and specifically, is a photograph when the nail sticker is removed from the support unit and then left for 24 hours after performing the first and second steps in a manufacturing method of a nail sticker described in the present invention.

FIG. 15 is a photograph of a nail sticker according to Example 2 of the present invention, and specifically, is a photograph immediately after removing the nail sticker manufactured by performing first and second steps of a manufacturing method of a nail sticker described in the present invention from a support unit.

FIG. 16 is a photograph of a nail sticker according to Example 2 of the present invention, and specifically, is a photograph when the nail sticker is removed from the support unit and then is left for 24 hours after performing the first and second steps in a manufacturing method of a nail sticker described in the present invention.

FIG. 17 is a photograph of a nail sticker according to Comparative Example 1 of the present invention and a photograph immediately after removing the manufactured nail sticker from a support unit.

FIG. 18 is a photograph of a nail sticker according to Comparative Example 1 of the present invention, and specifically, is a photograph when the nail sticker is removed from the support unit and then is left for 24 hours after performing the first and second steps in a manufacturing method of a nail sticker described in the present invention.

### MODE FOR CARRYING OUT THE DISCLOSURE

Those skilled in the art may make various modifications to the present invention and the present invention may have various embodiments thereof, and thus specific embodiments will be illustrated in the drawings and described in detail in detailed description.

However, this does not limit the present invention within specific exemplary embodiments, and it should be understood that the present invention covers all the modifications, equivalents and replacements within the spirit and technical scope of the present invention. In describing the present disclosure, when it is determined that a detailed description of related well-known technology may obscure the gist of the present disclosure, the detailed description thereof will be omitted.

Terms used in the present application are used only to describe a specific exemplary embodiment, but are not intended to limit the present invention. A singular form may include a plural form if there is no clearly opposite meaning in the context.

In the present application, it should be understood that term “include” or “have” indicates that a feature, a number, a step, an operation, a component, a part or the combination thereof described in the specification is present, but do not exclude a possibility of presence or addition of one or more other features, numbers, steps, operations, components, parts or combinations, in advance.

In the present invention, being disposed or located “on” may mean not only being present on the subject in a directly abutting state, but also being disposed or located on top of the subject in a spaced state.

In the present specification, a nail refers to a fingernail and/or toenail.

A thickness to be measured in the present invention is confirmed by equipment of VHX-970F available from Keyence.

In the specification, a “maximum thickness” of any configuration refers to the largest thickness, among thicknesses of the configuration measured along a vertical direction from an arbitrary point of a lower surface of the configuration.

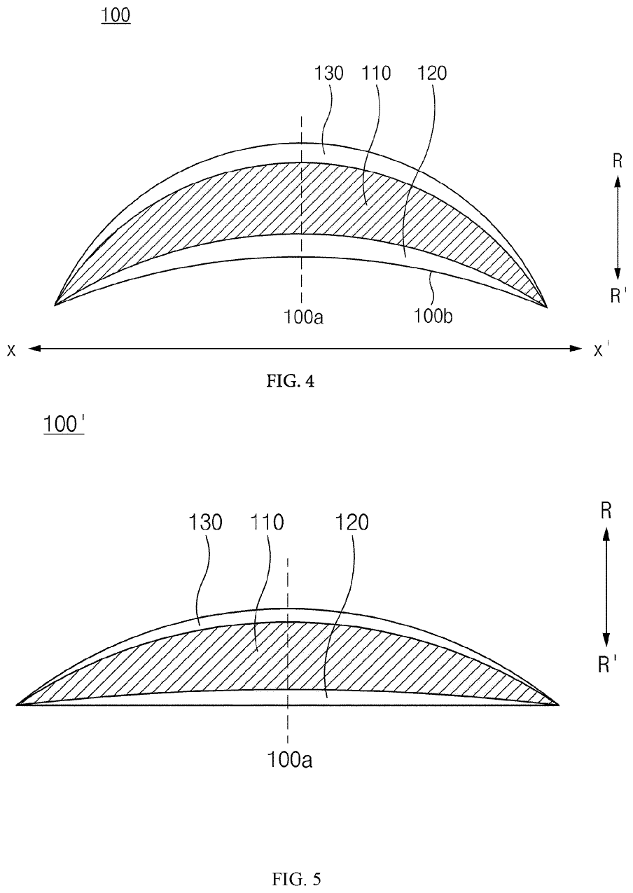

In the specification, when it is assumed that a R direction of FIGS. 1 and 4 is an upper direction, a upper surface of the nail sticker indicates a surface exposed toward the upper direction. Specifically, the upper surface of the nail sticker may be a surface through which a coating layer is exposed to the outside. In the specification, when it is assumed that a R′ direction of FIGS. 1 and 4 is a lower direction, a lower surface of the nail sticker indicates a surface exposed toward the lower direction. Specifically, the upper surface of the nail sticker may be a surface through which a base layer (specifically, an adhesive layer of the base layer) is exposed to the outside.

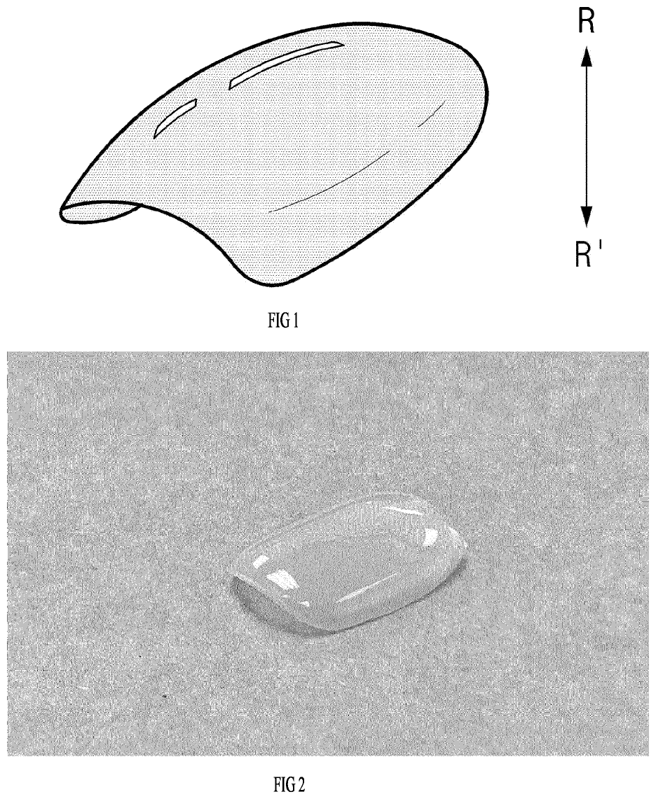

In the specification, a test to confirm a strain rate may be conducted with a nail sticker placed on a flat floor as illustrated in FIG. 2.

The nail sticker according to the present invention means a nail sticker that the user may arbitrary change the shape to be in contact with the user's nail and the nail sticker is cured by irradiating ultraviolet ray in a state that the nail sticker is adhered on the user's nail. Such a nail sticker is referred to as a gel nail sticker. Accordingly, the nail sticker of the present disclosure refers to a nail sticker which is not cured by the ultraviolet (on which the user does not irradiate the ultraviolet ray). In other words, all a nail sticker of the exemplary embodiment of the present invention, a nail sticker manufactured by the manufacturing method of a nail sticker of another exemplary embodiment of the present invention, and a nail sticker included in a nail sticker set of still another exemplary embodiment of the present invention may refer to a nail sticker which is not cured by the ultraviolet ray (is not irradiated with ultraviolet by a user).

In the specification, when the nail sticker is cured by irradiating the ultraviolet ray, a condition of the UV irradiation may mean that the ultraviolet ray with a wavelength of 100 nm to 400 nm is irradiated at an output of 1800 W for 10 to 40 seconds.

### <Nail Sticker>

The nail sticker refers to an artificial laminated structure which is manufactured to be attached on a nail (fingernail and/or toenail). In consideration of the purpose of attachment, it is also referred to as a nail art or a nail art sticker. Specifically, when a consumer is supplied with the nail sticker, the consumer attaches the nail art to the nail while deforming a shape of the nail sticker to be adhered onto the nail and then irradiates the ultraviolet to cure the nail sticker.

The nail sticker according to the exemplary embodiment of the present invention is a nail sticker which is curable by the ultraviolet ray and a lower surface of the nail sticker which is not cured by the ultraviolet includes a curved surface that a center of the nail sticker is curved upwardly.

FIG. 1 is a diagram of a nail sticker according to an exemplary embodiment of the present invention and FIG. 2 is a photograph of the nail sticker. Referring to FIGS. 1 and 2, a nail sticker according to an exemplary embodiment of the present invention may have a nail shape. A lower surface of the nail sticker is not flat, but has a convex shape.

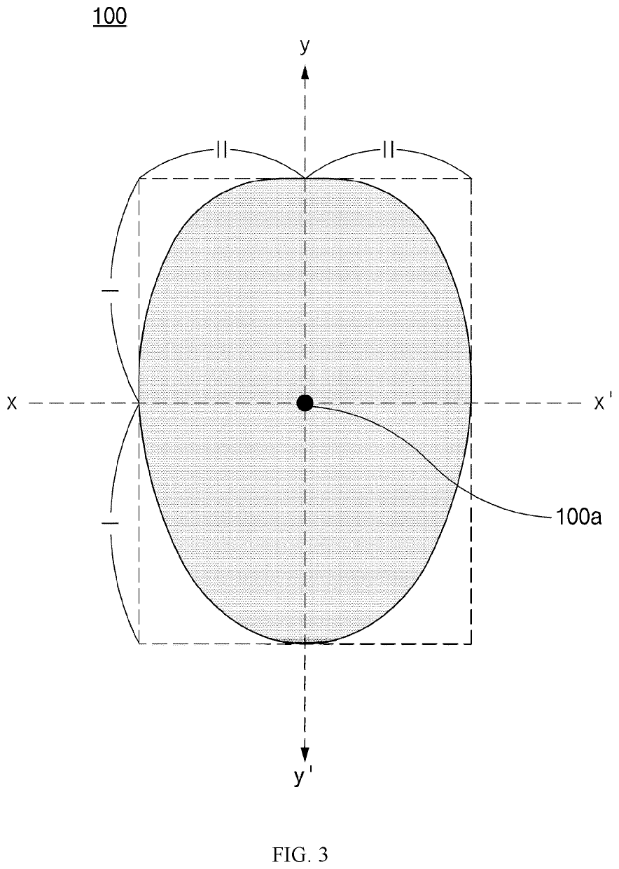

FIG. 3 is a top view of a nail sticker according to an exemplary embodiment of the present invention. Referring to FIG. 3, the nail sticker includes a long axis and a short axis. The long axis corresponds to an axis including an imaginary line segment corresponding to the longest length of the nail sticker, in a direction from a root of the nail to an end (a distal end adjacent to an ending point of the finger) of the nail when the nail sticker is worn on the nail (y-y′ of FIG. 3). Here, the length of the nail sticker refers to a size of the nail sticker in a direction from a root of the nail to an end (a distal end adjacent to an ending point of the finger) of the nail when the nail sticker is worn on the nail. The short axis corresponds to an axis including an imaginary line segment which is perpendicular to the long axis and corresponds to a width of the nail (a distance between two edges of the nail sticker adjacent to both side surfaces of the nail) when the nail sticker is worn on the nail and the length of the nail sticker is exactly divided into two parts by the short axis. The center 100a of the nail sticker refers to a point at which the long axis and the short axis of the nail intersect.

Referring to FIGS. 1 to 4 again, the lower surface 100b of the nail sticker before being cured by the ultraviolet ray includes a curved surface such that the center 100a of the nail sticker is upwardly curved. That is, in the nail sticker of the present invention, the flat lower surface is curved by the external force so that the center 100a of the nail sticker is curved upwardly. Further, the upper surface of the nail sticker also includes a curved surface that the center 100a of the nail sticker is upwardly curved. To be more specific, when the nail sticker is disposed on a flat floor such that the lower surface of the nail sticker before being cured by the ultraviolet ray faces the flat floor, the center 100a of the nail sticker may be spaced apart from the floor. Here, the lower surface 100b of the nail sticker refers to a surface toward the fingernail of the user and specifically, may be a surface including a surface through which the adhesive layer is exposed to the outside. When the nail sticker is placed on the flat floor such that the lower surface of the nail sticker before being cured by the ultraviolet ray faces the flat floor, at least a part of the edge of the nail sticker may be in contact with the flat floor.

However, such a shape is hardly found from the nail stickers of the related art which are curable by the ultraviolet ray. In the case of injection molded hard nail stickers, if a nail-shaped mold is used, the lower surface of the nail sticker can be manufactured to include a curved surface with the center of the nail sticker which faces upward. However, the nail sticker which is curable by the ultraviolet ray needs to have flexibility to allow the user to form to be fitted to the user's nail shape so that a soft material needs to be used therefor. When this material is used, if the nail sticker is manufactured by the nail shape mold, there is a problem in that materials are burned in the mold. Further, according to the manufacturing method of the nail sticker of the related art, the nail sticker is manufactured by stacking layers which configure the nail sticker on the flat floor and the lower surface of the nail sticker is inevitably flat during this process. In order to make the lower surface of the nail sticker of the related art which is curable by the ultraviolet ray the above-described curved surface, if an external force is applied to the manufactured nail sticker with a flat lower surface, the shape is deformed as soon as the external force is applied and the shape returns to the flat shape as soon as the external force is removed. That is, with the technology of the related art, it is never possible to manufacture the nail sticker (gel nail sticker) which is curable by the ultraviolet ray to have a curved shape like the nail shape.

However, the nail sticker of the present invention includes a layer which is not included in the related art so that the nail sticker may have a curved shape like the nail shape. Moreover, “having a curved shape” means that the nail sticker significantly maintains its curved shape state. In some cases, the nail sticker of the related art is manufactured by a manufacturing method which does not exist in the related art so that a curved state of the nail sticker may be further efficiently maintained. In other words, without intentionally applying an arbitrary external force (excluding a natural force such as gravity) to the nail sticker of the present invention, the lower surface of the nail sticker before being cured by the ultraviolet ray has a curved surface such that the center of the nail sticker is upwardly curved.

For example, in the nail sticker of the related art, the center of the lower surface of the nail sticker is upwardly curved. When the nail sticker is disposed on the flat floor such that the lower surface of the nail sticker faces upward, the center of the lower surface of the nail sticker is not in contact with the flat floor even after 24 hours.

The nail sticker includes a soft layer. The soft layer includes a resin for the soft layer. The resin for the soft layer may include at least any one of cellulose acetate butyrate and cellulose acetate propionate. Therefore, the nail sticker may be easily deformed to the nail shape during the manufacturing process of the nail sticker according to the exemplary embodiment of the present invention and the deformed shape of the nail sticker may be effectively maintained. As the soft layer is used, the lower surface of the nail sticker before being cured by the ultraviolet ray includes a curved surface so that the center of the nail sticker is upwardly curved. Further, when the user applies a predetermined force during a process of attaching the nail sticker, the soft layer fills a space floated between the nail and the nail sticker and the filled state is effectively maintained. Accordingly, the user will feel less a foreign body sensation and the adhesive strength of the nail sticker is increased. Further, when a part of the nail sticker extends beyond a nail area, the soft layer may serve to support the part of the nail sticker which extends and protrudes so as not to be deformed. Further, even though a nail surface has irregularities, more soft layer may be disposed on a recessed portion of the nail surface by applying a predetermined force. Accordingly, even though the nail surface has irregularities, the surface of the attached nail sticker has a smooth shape, which improves aesthetics. Moreover, cellulose acetate butyrate and cellulose acetate propionate have superior shock absorption advantages to other materials.

To be more specific, the resin for the soft layer includes cellulose acetate butyrate and for example, the resin for the soft layer may be cellulose acetate butyrate. In this case, a shock absorption ability and durability are excellent. Further, when the resin is mixed with a UV curing material for the soft layer, ductility is increased so that the deformation of the soft layer due to the external impact appears irreversible by the effect of shock absorption ability. The deformed shape may be more easily maintained. Accordingly, a nail sticker having a nail shape may be provided to the user.

The resin for the soft layer is included in the soft layer in an amount of 10 wt % to 90 wt %, and particularly, 15 wt % to 75 wt %, and more particularly, 30 wt % to 65 wt %. When the above range is satisfied, the soft layer is easily deformed in the level of a body temperature and the deformed shape of the soft layer may be maintained. Accordingly, a nail sticker having a nail shape may be provided to the user.

The soft layer further includes a ultraviolet curing material for the soft layer. Therefore, the soft layer may be cured by irradiating ultraviolet ray.

A ultraviolet curing material for the soft layer includes at least one selected from a group consisting of urethane acrylate-based oligomer, polyester acrylate-based oligomer, polyether acrylate-based oligomer, epoxy acrylate-based oligomer, polycarbonate acrylate-based oligomer, silicone acrylate-based oligomer, and acrylic acrylate-based oligomer.

Specifically, the ultraviolet curing material for the soft layer includes urethane acrylate-based oligomer, polyester acrylate-based oligomer, and epoxy acrylate-based oligomer.

Advantageously, the urethane acrylate-based oligomer is easily cured by the ultraviolet ray and also has a predetermined flexible physical property even after being cured. Further, haze phenomenon is minimized so that the transparency of a coating layer is maintained. The urethane acrylate-based oligomer may include at least one of a bi-functional urethane acrylate-based oligomer, a tetra-functional urethane acrylate-based oligomer, a hexa-functional urethane acrylate-based oligomer, and a nine-functional urethane acrylate-based oligomer. Specifically, the urethane acrylate-based oligomer includes at least one selected from a group of PU210, PU280, PU640, SC2404 manufactured by Miwon Specialty Chemical Co., Ltd., CN9033 and CN9047 manufactured by SATOMER. A weight average molecular weight of the urethane acrylate-based oligomer may be 1000 g/mol to 1000000 g/mol, and specifically, 1000 g/mol to 100000 g/mol. When the range is satisfied, the workability may be significantly improved.

The epoxy acrylate-based oligomer has high reactivity, high hardness, and good polishability, and easy to be cured, has excellent flexibility, and stably cured even in contact with oxygen. The epoxy acrylate-based oligomer has one or two functional groups and shows ductility with one functional group. The higher the number of functional groups, the more advantageous for rigidity or thermal stability. Specifically, the epoxy acrylate-based oligomer may include at least any one selected from a group consisting of PE210, PE2120, and PE250 manufactured by Miwon Specialty Chemical Co., Ltd. A weight average molecular weight of the epoxy acrylate-based oligomer may be 100 g/mol to 10000 g/mol, and specifically, 500 g/mol to 6000 g/mol. In consideration of a solid content and viscosity of the composition for forming a soft layer, the above-mentioned range is desirable.

The polyester acrylate-based oligomer has excellent reactivity and has better adhesive strength than the urethane acrylate-based oligomer and epoxy acrylate-based oligomer. The polyester acrylate-based oligomer may be an oligomer having four or six functional groups. Specifically, the polyester acrylate-based oligomer includes at least any one selected from a group consisting of PS4040, PS460, PS6300, Etermer 6311-100, 6312-100, 6314C-60 which are products of Miwon Specialty Chemical Co., Ltd. A weight average molecular weight of the polyester acrylate-based oligomer may be 500 g/mol to 50000 g/mol, and specifically, 1500 g/mol to 38000 g/mol. The above-mentioned range is satisfied, the processability and the adhesive strength may be improved.

In the soft layer, the epoxy acrylate-based oligomer may be included in an amount of 1 to 10 parts by weight based on 100 parts by weight of the urethane acrylate-based oligomer, and specifically, included in an amount of 1 to 3 parts by weight. In the soft layer, the polyester acrylate-based oligomer may be included in an amount of 10 to 20 parts by weight based on 100 parts by weight of the urethane acrylate-based oligomer, and specifically, included in an amount of 2 to 8 parts by weight. When the above composition is satisfied, even though the soft layer is exposed to the air, the soft layer is not rapidly cured and the durability may be maintained even after the nail sticker is attached.

In contrast, the ultraviolet curing material for the soft layer includes the urethane acrylate-based oligomer and specifically, is formed of the urethane acrylate-based oligomer.

The ultraviolet curing material for the soft layer is included in the soft layer in an amount of 10 wt % to 90 wt %, and specifically, 15 wt % to 75 wt %, and more specifically, 30 wt % to 65 wt %. When the above range is satisfied, the soft layer maintains a flexible property before irradiating ultraviolet ray and then becomes very hard after being cured by irradiating ultraviolet ray.

In the soft layer, the weight ratio of the ultraviolet curing material for the soft layer and the resin for the soft layer may be 10:90 to 90:10, specifically 20:80 to 80:20, more specifically 30:70 to 70:30. When the above-mentioned range is satisfied, a shock absorption property of the resin for the soft layer and the viscosity of the ultraviolet curing material for the soft layer are mixed to further increase an external striking energy absorption ability.

A photoinitiator for the soft layer serves to initiate polymerization reaction by irradiating ultraviolet ray. Specifically, the photoinitiator may be a UV photoinitiator.

The photoinitiator for the soft layer has an absorption wavelength band in the range of 200 nm to 600 nm.

The photoinitiator for the soft layer includes at least any one selected from a group of trimethylbenzoyl phosphine oxide, phenylbis(2,4,6-trimethylbenzoyl)phosphine oxide, and 2-benzyl-2-(dimethylamino)-1-[4-(4-morpholinyl)phenyl]-1-butanone, but is not necessarily limited thereto.

The photoinitiator for the soft layer is included in the soft layer in an amount of 1 wt % to 10 wt %, and specifically, 1 wt % to 8 wt %, and more specifically, 2 wt % to 7 wt %. If the above-mentioned range is satisfied, when the user cures the nail sticker, the nail sticker may have an appropriate hardness.

A maximum thickness of the soft layer may be 250 μm to 2500 μm, and particularly, 700 μm to 2400 μm, and more particularly, 1000 μm to 2000 μm. When the above-mentioned range is satisfied, the nail sticker of the present invention in which the lower surface of the nail sticker before being cured by the ultraviolet ray includes a curved surface that the center of the nail sticker is upwardly curved is easily manufactured. Further, when the above-mentioned range is satisfied, a sufficient amount of a part of the soft layer may move to minimize a lifting phenomenon between the nail sticker and the nail. Further, when a part of the nail sticker extends beyond the nail area, the soft layer may more effectively serve to support the part of the nail sticker which extends and protrudes so as not to be deformed. Further, even though the nail surface has irregularities, more soft layer may be sufficiently located on the recessed portion of the nail by the movement of the soft layer so that the surface of the attached nail sticker may have more smooth shape. Further, a deformation rate of the soft layer is not high due to the external shock so that the above-described effects may be smoothly maintained. The maximum thickness of the soft layer refers to the largest thickness of the thicknesses of the soft layer measured vertically from an arbitrary point of the lower surface of the soft layer.

The soft layer may be a single layer or may be formed of two or more layers.

The nail sticker further includes a base layer. The soft layer is disposed on the base layer.

Referring to FIG. 4, a upper surface of the base layer 120 and the lower surface of the soft layer 110 may be opposite to each other and specifically, are in contact with each other. That is, the soft layer 110 may be located on the base layer 120.

The base layer includes an adhesive layer. The adhesive layer imparts a chemical adhesive strength to allow the nail sticker to be attached on the nail. The adhesive layer is located below the nail sticker to configure at least a part of the lower surface of the nail sticker.

The adhesive layer may configure at least a part of the lowest surface of the nail sticker. The adhesive layer includes an adhesive component which may correspond to an adhesive component commonly used in the field.

The base layer further includes a design layer. The design layer is located between the adhesive layer and the soft layer. The design layer includes at least any one of a color layer and a printed layer. The design layer may include a pigment which gives colors to the nail sticker. The printed layer includes various materials for aesthetics, such as particles and talc for pattern expression.

A base film is disposed on the lower surface of the base layer. The base film serves to maintain the adhesive strength before using the nail sticker by preventing the contamination of the adhesive layer and is removed when the nail sticker is used. The base film may include a component which is commonly used in the field.

The nail sticker further includes a coating layer.

Referring to FIG. 4, the coating layer 130 is located on the soft layer 110 in the nail sticker 100.

The coating layer includes an ultraviolet curing material for a coating layer and a resin for a coating layer.

As the ultraviolet curing material for a coating layer is included in the coating layer, the user deforms the nail sticker to be closely adhered with the user's nail, and then irradiates the ultraviolet ray to cure the nail sticker with a deformed shape of the nail sticker. Therefore, the nail sticker and the fingernail/toenail can be bonded to each other in complete contact so that the nail sticker adhesive strength may be improved.

A ultraviolet curing material for the coating layer includes at least one selected from a group consisting of urethane acrylate-based oligomer, polyester acrylate-based oligomer, polyether acrylate-based oligomer, epoxy acrylate-based oligomer, polycarbonate acrylate-based oligomer, silicone acrylate-based oligomer, and acrylic acrylate-based oligomer.

Specifically, the ultraviolet curing material for the coating layer includes urethane acrylate-based oligomer, polyester acrylate-based oligomer, and epoxy acrylate-based oligomer.

Advantageously, the urethane acrylate-based oligomer is easily cured by the ultraviolet ray and also has a predetermined flexible physical property even after being cured. Further, haze phenomenon is minimized so that the transparency of a coating layer is maintained. The urethane acrylate-based oligomer may include at least one of a bi-functional urethane acrylate-based oligomer, a tetra-functional urethane acrylate-based oligomer, a hexa-functional urethane acrylate-based oligomer, and a nine-functional urethane acrylate-based oligomer. Specifically, the urethane acrylate-based oligomer includes at least one selected from a group of PU210, PU280, PU640, SC2404 manufactured by Miwon Specialty Chemical Co., Ltd., CN9033 and CN9047 manufactured by SATOMER. A weight average molecular weight of the urethane acrylate-based oligomer may be 1000 g/mol to 1000000 g/mol, and specifically, 1000 g/mol to 100000 g/mol. The above-mentioned range is satisfied, the workability may be significantly improved.

The epoxy acrylate-based oligomer has high reactivity, high hardness, and good polishability, and easy to be cured, has excellent flexibility, and stably cured even in contact with oxygen. The epoxy acrylate-based oligomer has one or two functional groups and shows ductility with one functional group. The higher the number of functional groups, the more advantageous for rigidity or thermal stability. Specifically, the epoxy acrylate-based oligomer may include at least any one selected from a group consisting of PE210, PE2120, and PE250 manufactured by Miwon Specialty Chemical Co., Ltd. A weight average molecular weight of the epoxy acrylate-based oligomer may be 100 g/mol to 10000 g/mol, and specifically, 500 g/mol to 6000 g/mol. In consideration of a solid content and viscosity of the composition for forming a coating layer, the above-mentioned range is desirable.

The polyester acrylate-based oligomer has excellent reactivity and has better adhesive strength than the urethane acrylate-based oligomer and epoxy acrylate-based oligomer. The polyester acrylate-based oligomer may be an oligomer having four or six functional groups. Specifically, the polyester acrylate-based oligomer includes at least any one selected from a group consisting of PS4040, PS460, PS6300, Etermer 6311-100, 6312-100, 6314C-60 which are products of Miwon Specialty Chemical Co., Ltd. A weight average molecular weight of the polyester acrylate-based oligomer may be 500 g/mol to 50000 g/mol, and specifically, 1500 g/mol to 38000 g/mol. The above-mentioned range is satisfied, the processability and the adhesive strength may be improved.

In the coating layer, the epoxy acrylate-based oligomer may be included in an amount of 1 to 10 parts by weight based on 100 parts by weight of the urethane acrylate-based oligomer, and specifically, included in an amount of 1 to 3 parts by weight. In the coating layer, the polyester acrylate-based oligomer may be included in an amount of 10 to 20 parts by weight based on 100 parts by weight of the urethane acrylate-based oligomer, and specifically, included in an amount of 2 to 8 parts by weight. When the above composition is satisfied, even though the coating layer is exposed to the air, the soft layer is not rapidly cured and the durability may be maintained even after the nail sticker is attached.

In contrast, the ultraviolet curing material for the coating layer includes the urethane acrylate-based oligomer and specifically, is formed of the urethane acrylate-based oligomer.

The ultraviolet curing material for the coating layer is included in the coating layer in an amount of 10 wt % to 90 wt %, and specifically, 10 wt % to 60 wt %, and more specifically, 20 wt % to 50 wt %. When the above range is satisfied, the coating layer maintains a flexible property before irradiating ultraviolet ray and then becomes very hard after being cured by irradiating ultraviolet ray.

The resin for a coating layer serves to maintain a shape by controlling a flowability of the coating layer. Further, the resin for a coating layer allows a composition for forming the coating layer to have an appropriate viscosity so that the coating layer may be manufactured in a desired shape.

The resin for the coating layer may be a thermoplastic resin for the coating layer having a glass transition temperature (Tg) of 30° C. to 200° C., and specifically 50° C. to 120° C. When the above-mentioned range is satisfied, the mobility of the resin for the coating layer is not high at room temperature, but during the manufacturing process of the nail sticker, the resin for the coating layer is properly mixed with the UV curing material in a drying furnace, so that the side lines of the nail sticker are smoothly formed.

The resin for the coating layer may include at least any one selected from the group consisting of an acrylic resin for a coating layer, a nitrocellulose resin for a coating layer, an epoxy resin for a coating layer, a polyester resin for a coating layer, a polyvinyl resin for a coating layer, a urethane resin for a coating layer, and a vinyl acetate resin for a coating layer.

Particularly, the resin for the coating layer includes an acrylic resin for a coating layer and a nitrocellulose resin for a coating layer. A glass transition temperature (Tg) of the acrylic resin for the coating layer may be 30° C. to 200° C., and specifically 50° C. to 120° C. The nitrocellulose resin for the coating layer includes HRS ⅛ to 20 SS type ⅛ to ½ of Korea CNC Ltd. A nitrogen content of the nitrocellulose resin for a coating layer may be 11.5% to 12.2%, and specifically, divided into ⅛ seconds to 20 seconds depending on a viscosity. When the above-mentioned range is maintained, the low viscosity can be maintained to increase a solid content.

The resin for the coating layer is included in the coating layer in an amount of 10 wt % to 90 wt %, and specifically, 15 wt % to 75 wt %, and more specifically, 15 wt % to 65 wt %. When the above-mentioned range is satisfied, the stickiness disappears so that there is no problem even in handling at room temperature and a round shape may be formed.

In the meantime, the resin for a coating layer includes a thermosetting resin for a coating layer and a thermal initiator.

The coating layer further includes a photoinitiator for a coating layer.

The photoinitiator serves to initiate polymerization reaction by irradiating the ultraviolet ray. Specifically, the photoinitiator may be a UV photoinitiator.

The photoinitiator for the coating layer has an absorption wavelength band in the range of 200 nm to 600 nm.

The photoinitiator for the coating layer includes at least any one selected from a group of trimethylbenzoyl phosphine oxide, phenylbis(2,4,6-trimethylbenzoyl)phosphine oxide, and 2-benzyl-2-(dimethylamino)-1-[4-(4-morpholinyl)phenyl]-1-butanone, but is not necessarily limited thereto.

The photoinitiator for the coating layer is included in the coating layer in an amount of 1 wt % to 10 wt %, and specifically, 1 wt % to 8 wt %, and more specifically, 2 wt % to 7 wt %. If the above-mentioned range is satisfied, when the user cures the coating layer, the coating layer may have an appropriate hardness.

In some cases, the coating layer includes a solvent. The solvent corresponds to a solvent used to form a composition for forming a coating layer to manufacture the coating layer and is dried to be removed during the manufacturing process of the coating layer. However, some solvent remains at a very low content in the coating layer.

The nail sticker further includes a design expression layer disposed on the coating layer. The design expression layer may show expressions such as matte and also show three-dimensional lines or a thick film type three-dimensional figure, such as a cone or a circular dome.

A maximum thickness of the nail sticker may be 500 μm to 2500 μm, and particularly, 700 μm to 2000 μm, and more particularly, 1000 μm to 1800 μm. When the above-mentioned range is satisfied, the aesthetics are high and the nail sticker is not broken during the UV curing and a nail tightening phenomenon is reduced.

In the nail sticker, when the nail sticker is disposed on the flat floor so that the lower surface of the nail sticker before being cured by the ultraviolet ray faces the flat floor, a strain rate according to following Equation 1 is 4% or lower in the atmosphere of a temperature of 25° C., and specifically, 0% to 3%, and more specifically 0% to 2.1%.

Strain rate=[(B−A)/A]×100 [Equation 1]

In Equation 1, A refers to a maximum value of a width of the nail sticker measured immediately after placing the nail sticker on the flat floor and B refers to a maximum value of a width of the nail sticker measured one hour after placing the nail sticker on the flat floor. In the specification, “on the flat floor” means immediately on the flat floor.

The nail sticker has a strain rate of 30% or less according to Equation 1 below in an atmosphere of a temperature of 25° C., so that the shape of the nail sticker may be maintained as much as possible even during the process of supplying the product to the user. Further, the user may more easily mold the nail sticker to fit the user's nail shape. In a series of processes of attaching and curing the nail sticker by the user, the molded shape of the molded nail sticker can be maintained well so that the user may conveniently use the nail sticker and wear the nail sticker fitted to the user's nail.

The strain rate corresponds to a value which is much lower than that of the UV curable nail sticker of the related art. The nail sticker of the present exemplary embodiment includes the soft layer, which may become the main reason for the low strain rate.

To be more specific, the strain rate of the nail sticker in an atmosphere of a temperature of 25° C. is 2.2% or lower, and specifically, 0% to 2.2%, and 0% to 2.1%. Together with the usage of the soft layer, a process of applying heat after deforming the nail sticker to the nail shape during the manufacturing process of a nail sticker may become the main reason for the lower strain rate as described above.

In the nail sticker, when the nail sticker is disposed on the flat floor so that the lower surface of the nail sticker before being cured by the ultraviolet ray faces the flat floor, the strain rate of Equation 1 in the atmosphere of −10° C. is 0.2% or lower, and specifically, 0% to 0.2%, and more specifically, 0% to 0.10%.

$$Strain rate = [ ( B - A ) / A ] \times 100 \qquad [ Equation 1 ]$$

In Equation 1, A refers to a maximum value of a width of the nail sticker measured immediately after placing the nail sticker on the flat floor and B refers to a maximum value of a width of the nail sticker measured one hour after placing the nail sticker on the flat floor.

The nail sticker has a strain rate of 0.2% or less according to Equation 1 below in an atmosphere of −10° C., so the shape of the nail sticker is maintained even at low temperatures (e.g., when stored in a low temperature place or in winter). Therefore, the shape of the nail sticker can be maintained as much as possible even during the process of supplying the product to the user.

In the nail sticker, when the nail sticker is disposed on the flat floor so that the lower surface of the nail sticker before being cured by the ultraviolet ray faces the flat floor, the strain rate according to Equation 1 in the atmosphere of 40° C. is 6% or lower, and specifically, 4.5% or lower, and more specifically, 0% to 4.3% and for example, 0% to 3%.

$$Strain rate = [ ( B - A ) / A ] \times 100 \qquad [ Equation 1 ]$$

In Equation 1, A refers to a maximum value of a width of the nail sticker measured immediately after placing the nail sticker on the flat floor and B refers to a maximum value of a width of the nail sticker measured one hour after placing the nail sticker on the flat floor.

The nail sticker has a strain rate of 6% or less according to Equation 1 below in an atmosphere of 40° C., so the shape of the nail sticker is maintained even at high temperatures (e.g., when stored in a high temperature place or in summer). Therefore, the shape of the nail sticker can be maintained as much as possible even during the process of supplying the product to the user.

In the nail sticker, when the nail sticker is disposed on the flat floor so that the lower surface of the nail sticker before being cured by the ultraviolet ray faces the flat floor, the strain rate according to Equation 1 in the atmosphere of 60° C. is 8% or lower, and specifically, 7% or lower, and more specifically, 0% to 7% and for example, 0% to 5%.

$$Strain rate = [ ( B - A ) / A ] \times 100 \qquad [ Equation 1 ]$$

In Equation 1, A refers to a maximum value of a width of the nail sticker measured immediately after placing the nail sticker on the flat floor and B refers to a maximum value of a width of the nail sticker measured one hour after placing the nail sticker on the flat floor.

The nail sticker has a strain rate of 6% or less according to Equation 1 below in an atmosphere of 60° C., so the shape of the nail sticker is maintained even at high temperatures (e.g., when stored in a high temperature place or in summer). Therefore, the shape of the nail sticker can be maintained as much as possible even during the process of supplying the product to the user.

In the nail sticker, when the nail sticker before being cured by the ultraviolet ray is placed on the flat floor and an area including the center of the upper surface of the nail sticker is pushed with a force of 10 N using PUSH GAGE equipment of IMADA Inc., the lower surface of the center of the nail sticker may touch the floor. That is, it is understood that the nail sticker is not a hard molded product, but may be a nail sticker (so-called, gel nail sticker) which is flexible to be easily deformable when an external force is applied.

### <Manufacturing Method of Nail Sticker>

A manufacturing method of a nail sticker according to another exemplary embodiment of the present invention includes a first step of placing a UV curable preliminary nail sticker on a support unit included in a support structure; and a second step of adhering a lower surface of the preliminary nail sticker to an upper surface of the support unit by applying a pressure to an upper surface of the preliminary nail sticker, and the support unit has a curved surface upwardly convex and a lower surface of the nail sticker before being cured by the ultraviolet ray includes a curved surface that a center of the nail sticker is upwardly curved.

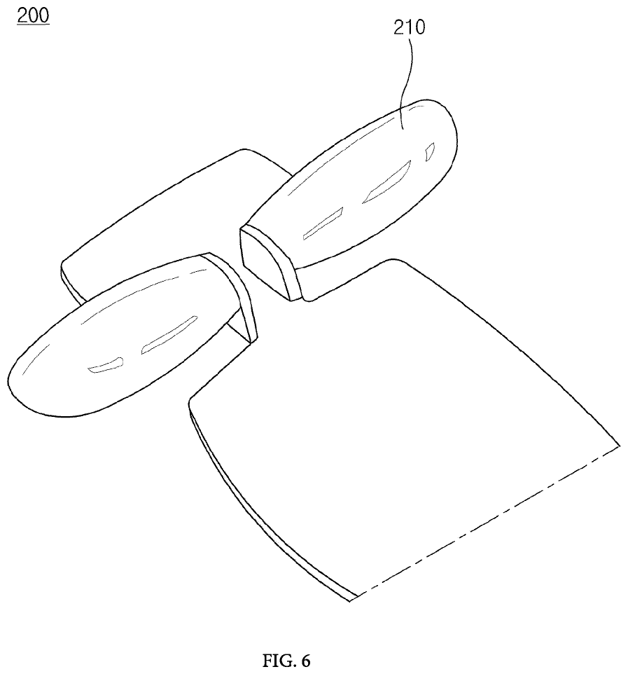

In the first step, the UV curable preliminary nail sticker 100′ may have a shape as illustrated in FIG. 5 before being placed on the support unit. That is, even though the lower surface is flat or curved, the curve of the preliminary nail sticker 100′ is not severe as compared with the normal nail. In other words, before placing the preliminary nail sticker 100′ on the support structure, when the nail sticker is put on the flat floor such that the lower surface of the preliminary nail sticker 100′ before being cured by the ultraviolet ray faces the flat floor, the lower surface of the preliminary nail sticker may be flat.

The preliminary nail sticker 100′ includes a soft layer 110 and further includes a base layer 120. Alternatively, the preliminary nail sticker may include a soft layer 110, a base layer 120, and a coating layer 130. Here, the soft layer, the base layer, and the coating layer have the same configurations as the soft layer, the base layer, and the coating layer which have been described to be included in the nail sticker of the exemplary embodiment described above so that the description thereof will be omitted.

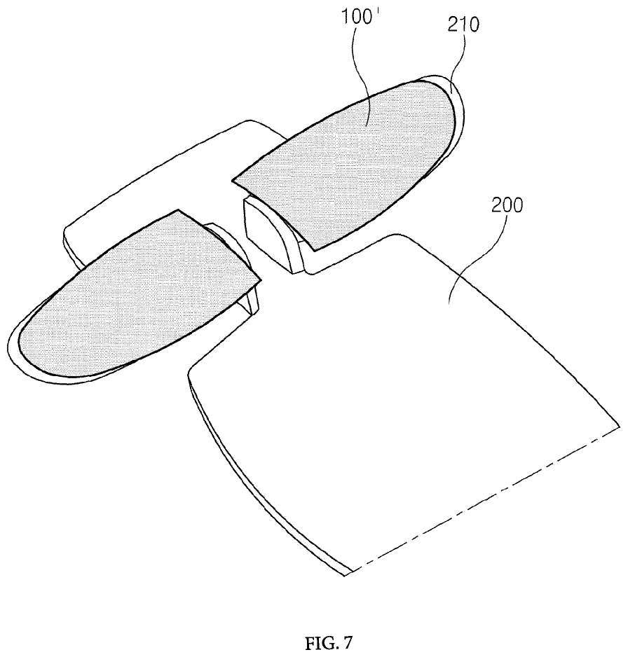

Referring to FIG. 7, in the first step, the UV curable preliminary nail sticker 100′ (which has not been cured) is disposed on the support structure 200 including the support unit 210 having a curved surface which is upwardly convex. FIG. 6 is a diagram of the support structure 200. The support structure 200 includes one or more support units 210 and specifically, includes two or more support units 210. The support unit 210 may have a curved surface that is upwardly convex, and specifically, the support unit 210 may have a nail shape. The preliminary nail sticker 100′ may be disposed on the support unit 210 so that the lower surface of the preliminary nail sticker 100′ is in contact with the upper surface of the support unit 210.

A material of the upper surface of the support unit may include at least one selected from the group consisting of polyethylene, polypropylene, and silicone, and may specifically include polyethylene, and more specifically, the upper surface of the support unit may be configured by polyethylene. The upper surface of the support unit includes polyethylene so that the adhesive strength of the nail sticker and the support unit is not so high. Therefore, when the nail sticker is separated from the support unit, an unintended deformation of the nail sticker may be minimized.

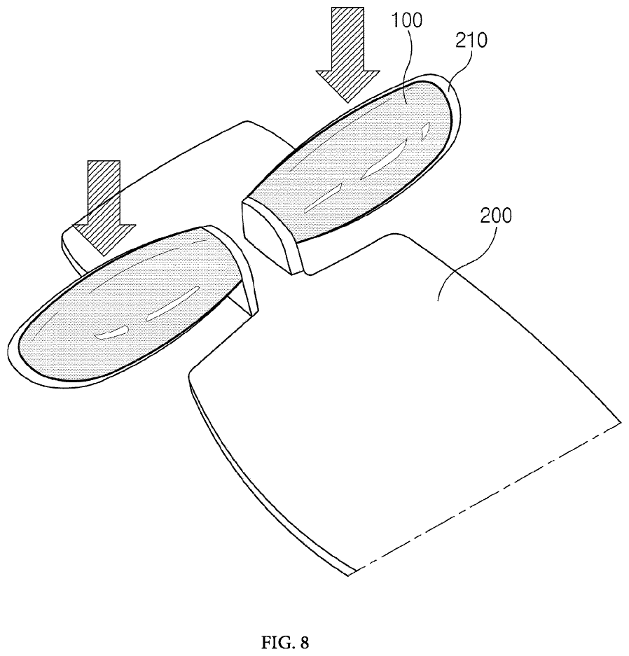

Referring to FIG. 8, in the second step, the lower surface of the preliminary nail sticker is in close contact with the upper surface of the support unit by applying a pressure toward the upper surface of the preliminary nail sticker. Specifically, the preliminary nail sticker may be brought into close contact with the support portion 210 by applying a pressure to the upper surface of the preliminary nail sticker using a pressing member having a recessed portion recessed in the shape of a nail. However, the method is not necessarily limited to the above method, and another method for closely adhering the preliminary nail sticker with the support unit 210 is also possible. The nail sticker 100 according to the exemplary embodiment of the present invention may be manufactured by means of the second step. That is, the lower surface of the nail sticker before being cured by the ultraviolet ray includes a curved surface that the center of the nail sticker is upwardly curved.

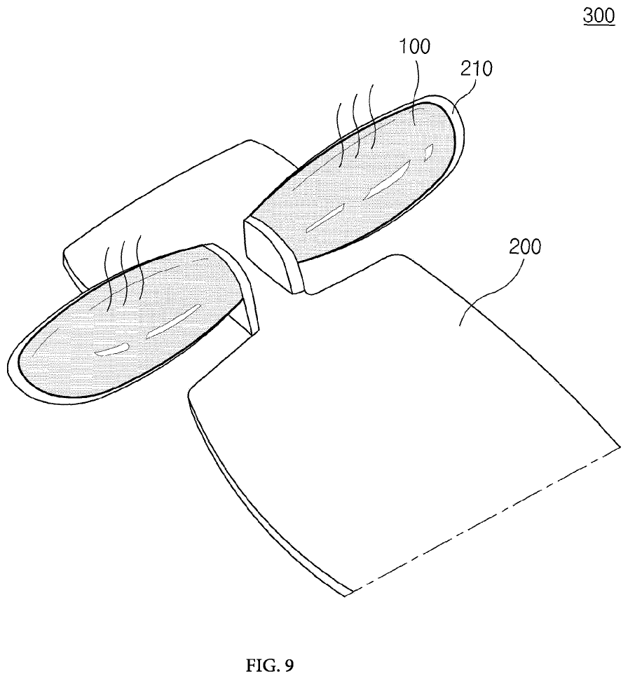

Referring to FIG. 9, in some cases, the manufacturing method of the nail sticker further includes a third step of applying a heat to the preliminary nail sticker 100′ adhered on the support unit 210 after the second step. By doing this, the nail shape (in which the lower surface of the nail sticker before being cured by the ultraviolet ray includes a curved surface that the center of the nail sticker is upwardly curved) of the nail sticker may be more effectively maintained. The heat applied in the third step may be a heat having a temperature of 30° C. to 70°, and specifically, a heat having a temperature of 45° C. to 55° C. When the above range is satisfied, a degree of deforming a shape of the product when the product is stored is significantly lowered while maintaining the flexible property. The heat may be applied for 20 seconds to three minutes, and specifically, for 30 seconds to two minutes. The heat may be applied by applying hot air or near-infrared rays.

### <Nail Sticker Set>

A nail sticker set according to still another exemplary embodiment of the present invention includes a support structure including a support unit and a nail sticker attached on an upper surface of the support unit. The upper surface of the support unit includes a curved surface that the center of the sticker is upwardly curved and the nail sticker is curable by the ultraviolet ray. The lower surface of the nail sticker before being cured by the ultraviolet ray includes a curved surface that the center of the nail sticker is upwardly curved. Here, the nail sticker is the same as the nail sticker of the above-described exemplary embodiment so that the physical properties of the nail sticker of the above-described exemplary embodiment is the same as physical properties of the nail sticker (a nail sticker removed from the support structure) mentioned in the present exemplary embodiment. Further, referring to FIG. 10, the support structure 200 is the same as the support structure mentioned in another exemplary embodiment described above.

Referring to FIG. 10, in the nail sticker set 300, the nail sticker 100 is disposed on the support unit 210. Both the nail sticker 100 and the support unit 210 have the nail shape and overlap each other. That is, the lower surface of the nail sticker before being cured by the ultraviolet ray includes a curved surface that the center of the nail sticker is upwardly curved and the support unit also has the same shape.

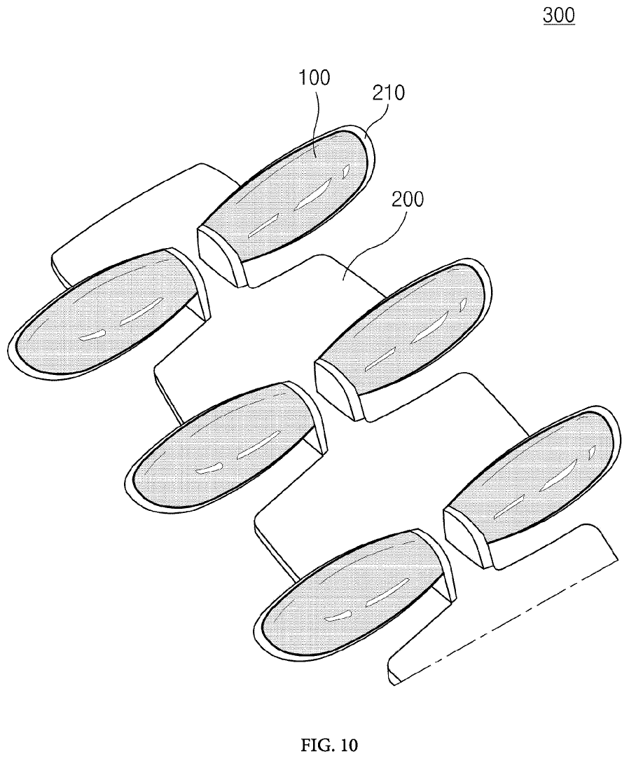

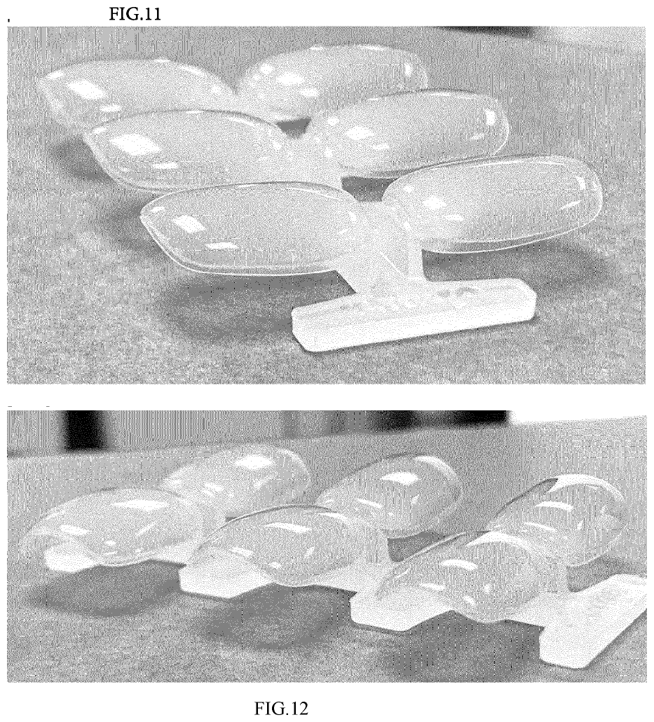

FIGS. 11 and 12 are photographs of a nail sticker set according to an exemplary embodiment of the present invention. 50% or more, specifically 70% or more, and more specifically 90% to 100%, for example, 95% to 100% of the lower surface of the nail sticker may be in contact with the upper surface of the support portion. This means that the nail sticker described in the present invention may effectively maintain the nail shape so that the separation of the lower surface of the nail sticker and the support structure during the process of delivering the nail sticker to the user may be minimized.

When the nail sticker is removed from the support unit and the nail sticker is disposed on the flat floor such that the lower surface of the nail sticker before being cured by the ultraviolet ray faces the flat floor, the center of the nail sticker may be spaced apart from the floor. Therefore, the user may more easily mold the nail sticker to fit the user's nail shape. In a series of processes of attaching and curing the nail sticker by the user, the molded shape of the molded nail sticker can be maintained well so that the user may conveniently use the nail sticker and apply the nail sticker fitted to the user's nail.

When the nail sticker is removed from the support unit and is disposed on the flat floor so that the lower surface of the nail sticker before being cured by the ultraviolet ray faces the flat floor, the strain rate of Equation 1 in the atmosphere of a temperature of 25° C. is 4% or lower, and specifically, 0% to 3%, and more specifically, 0% to 2.1%.

$$Strain rate = [ ( B - A ) / A ] \times 100 \qquad [ Equation 1 ]$$

In Equation 1, A refers to a maximum value of a width of the nail sticker measured immediately after placing the nail sticker on the flat floor and B refers to a maximum value of a horizontal length of the nail sticker measured one hour after placing the nail sticker on the flat floor.

The nail sticker has a strain rate of 4% or less according to Equation 1 below in an atmosphere of a temperature of 25° C., so that the shape of the nail sticker may be maintained as much as possible even during the process of supplying the product to the user. Further, the user may more easily mold the nail sticker to fit the user's nail shape. In a series of processes of attaching and curing the nail sticker by the user, the molded shape of the molded nail sticker can be maintained well so that the user may conveniently use the nail sticker and apply the nail sticker fitted to the user's nail.

A material of the upper surface of the support unit may include at least one selected from the group consisting of polyethylene, polypropylene, and silicone, and may specifically include polyethylene, and more specifically, the upper surface of the support unit may be configured by polyethylene. The upper surface of the support unit includes polyethylene so that the adhesive strength of the nail sticker and the support unit is not so high. Therefore, when the nail sticker is separated from the support unit, an unintended deformation of the nail sticker may be minimized.

The support structure includes one or more support units, and specifically, two or more support units and the nail sticker set includes one or more nail stickers, and specifically, two or more nail stickers.

Hereinafter, preferred examples will be provided in order to assist in the understanding of the present invention, but it will be obvious that the following examples are only illustrative of the present invention and various modifications and alternations may be made within the scope and technical idea of the present invention and also it will be natural that these modifications and alternations may fall within the scope of the appended claims, to those skilled in the art.

### EXAMPLES AND COMPARATIVE EXAMPLE

### Example 1

### (1) Preparation of Preliminary Nail Sticker

A nail sticker including a base layer (maximum thickness is 150 μm) including an adhesive layer and a design layer, a soft layer (maximum thickness is 2000 μm) disposed on the base layer, and a coating layer (maximum thickness is 65 μm) disposed on the soft layer was prepared.

The soft layer included 60 wt % of cellulose acetate butyrate as a resin for the soft layer, 38 wt % of urethane acrylate oligomer as an UV curing raw material for the soft layer, and 2 wt % of phenylbis(2,4,6-trimethylbenzoyl)phosphine oxide as a photoinitiator for the soft layer.

The coating layer included urethane acrylate as an UV curing raw material for the coating layer and phenylbis(2,4,6-trimethylbenzoyl)phosphine oxide as a resin for the coating layer.

### (2) Molding of Preliminary Nail Sticker

A support structure including a support unit having an upper surface with a convex center like an upper surface of the fingernail was prepared. The preliminary nail sticker was disposed on the upper surface of the support unit. At this time, the adhesive layer on the lower surface of the preliminary nail sticker was in contact with the upper surface of the support unit.

Thereafter, the lower surface of the preliminary nail sticker was brought into contact with the upper surface of the support unit included in the support structure by applying a pressure to the upper surface of the preliminary nail sticker. Therefore, the preliminary nail sticker supported by the nail sticker had a shape that the center thereof was upwardly curved, like the fingernail.

A nail sticker set including a nail sticker and a support structure was manufactured by applying a heat of 50° C. for two minutes by irradiating near infrared ray onto the preliminary nail sticker disposed on the support structure. The curing process by irradiating ultraviolet ray was not present in the manufacturing process.

### Example 2

### (1) Preparation of Preliminary Nail Sticker

A nail sticker including a base layer (maximum thickness is 150 μm) including an adhesive layer and a design layer, a soft layer (maximum thickness is 2000 μm) disposed on the base layer, and a coating layer (maximum thickness is 65 μm) disposed on the soft layer was prepared.

The soft layer included 60 wt % of cellulose acetate butyrate as resin for the soft layer, 38 wt % of urethane acrylate oligomer as an UV curing raw material for the soft layer, and 2 wt % of phenylbis(2,4,6-trimethylbenzoyl)phosphine oxide as a photoinitiator for the soft layer.

The coating layer included urethane acrylate as an UV curing raw material for the coating layer and phenylbis(2,4,6-trimethylbenzoyl)phosphine oxide as a resin for the coating layer.

### (2) Molding of Preliminary Nail Sticker

A support structure including a support unit having an upper surface with a convex center like an upper surface of the fingernail was prepared. The preliminary nail sticker was disposed on the upper surface of the support unit. At this time, an adhesive layer of the lower surface of the preliminary nail sticker was in contact with the upper surface of the support unit by applying a pressure to the upper surface of the preliminary nail sticker. Therefore, the preliminary nail sticker supported by the nail sticker had a shape that the center thereof was upwardly curved, like the fingernail.

The preliminary nail sticker supported by the support unit was left at room temperature for two hours to manufacture a nail sticker set including a nail sticker and a support structure. The curing process by irradiating ultraviolet ray was not present in the manufacturing process.

### Comparative Example 1

### (1) Preparation of Preliminary Nail Sticker

A nail sticker including a base layer (maximum thickness is 150 μm) including an adhesive layer and a design layer, a first coating layer (maximum thickness is 2000 μm) disposed on the base layer, and a second coating layer (maximum thickness is 65 μm) disposed on the first coating layer was prepared.

The first coating layer included 60 wt % of nitrocellulose as a resin for the first coating layer, 38 wt % of urethane acrylate oligomer as an ultraviolet curing raw material for the first coating layer, and 2 wt % of phenylbis (2,4,6-) trimethylbenzoyl)phosphine oxide as a photoinitiator for the first coating layer.

The second coating layer included urethane acrylate as an ultraviolet curing raw material for the second coating, phenylbis(2,4,6-trimethylbenzoyl)phosphine oxide as a photoinitiator for the second coating layer, and nitrocellulose as a resin for the second coating layer.

### (2) Molding of Preliminary Nail Sticker

A support structure including a support unit having an upper surface with a convex center like an upper surface of the fingernail was prepared. The preliminary nail sticker was disposed on the upper surface of the support unit. At this time, the adhesive layer on the lower surface of the preliminary nail sticker is in contact with the upper surface of the support unit. Thereafter, the lower surface of the preliminary nail sticker was brought into contact with the upper surface of the support unit included in the support structure by applying an external force to the upper surface of the preliminary nail sticker. Therefore, the preliminary nail sticker supported by the nail sticker has a shape that the center thereof is upwardly curved, like the fingernail.

The preliminary nail sticker supported by the support unit was left at room temperature for two hours to manufacture a nail sticker set including a nail sticker and a support structure.

The curing process by irradiating ultraviolet ray was not present in the manufacturing process.

### Experimental Example 1: Evaluation of Whether to Maintain Shape and Strain Rate

### (1) Evaluation at 25° C.

Immediately after separating the nail sticker of Example 1 from the support unit, the nail sticker (which has not been cured by the ultraviolet ray) was placed on the flat floor. Specifically, when the nail sticker before being cured was disposed on the flat floor so that the lower surface of the nail sticker before being cured faced down, the center of the nail sticker was spaced apart from the floor so that the curved shape of the nail sticker that the center faced upward was maintained.

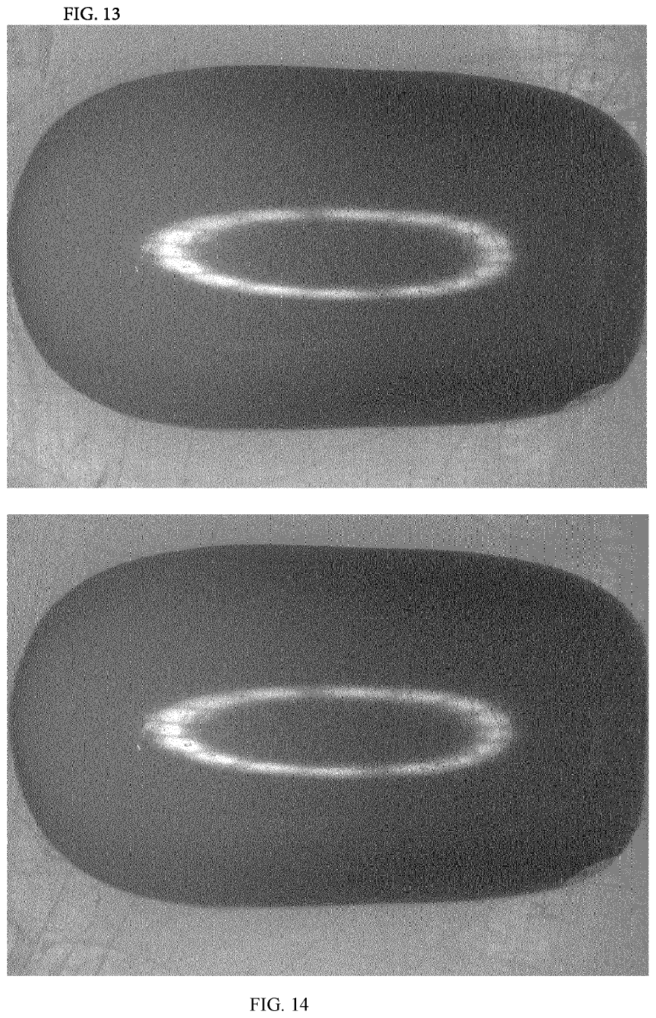

A specific result was represented in Table 1 and FIGS. 13 to 18.

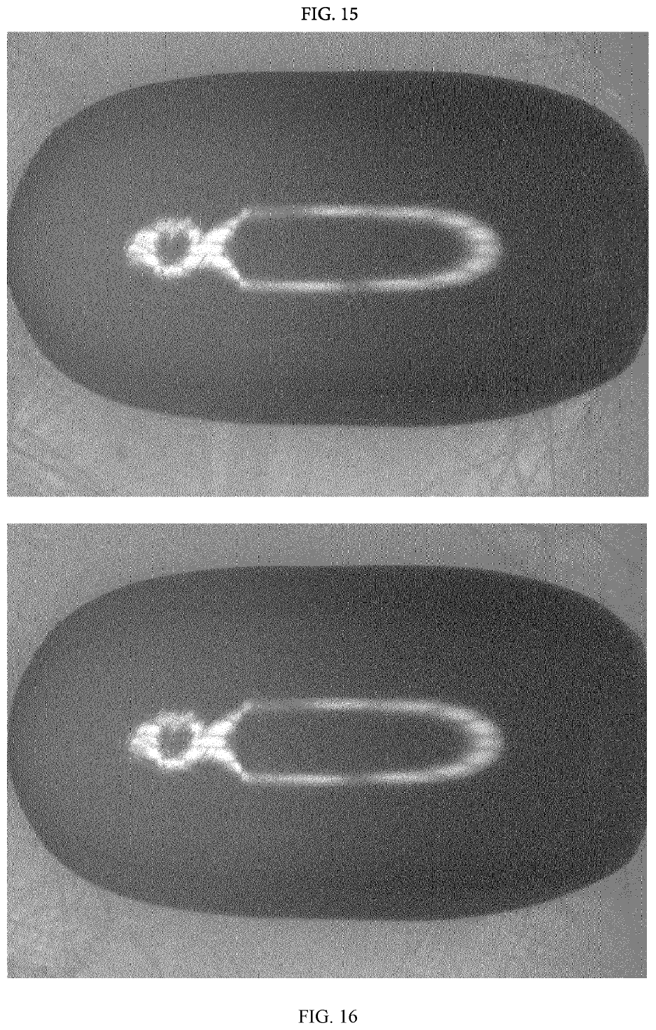

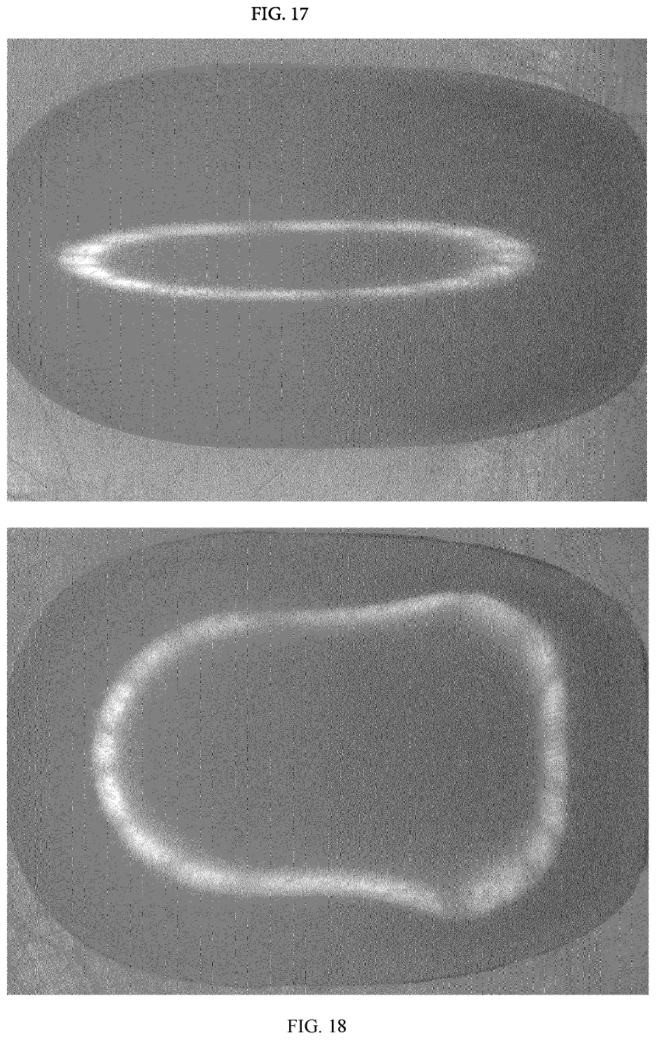

FIG. 13 is a photograph immediately after manufacturing a nail sticker of Example 1, FIG. 14 is a photograph of the manufactured nail sticker of Example 1 after being left for 24 hours, FIG. 15 is a photograph immediately after manufacturing a nail sticker of Example 2, FIG. 16 is a photograph of the manufactured nail sticker of Example 2 after being left for 24 hours, FIG. 17 is a photograph immediately after manufacturing a nail sticker of Comparative Example 1, and FIG. 18 is a photograph of the manufactured nail sticker of Comparative Example 1 after being left for 24 hours.

It is understood that the nail stickers of Examples 1 and 2 maintain the shape even after 24 hours, but the nail sticker of Comparative Example cannot maintain the shape after 24 hours.

### (2) Evaluation at −10° C., 40° C., and 60° C.

The above experiments were conducted at −10° C., 40° C., and 60° C. and represented in Table 1.

TABLE 1

| | | | | Comp. |
|---|---|---|---|---|
| | | Example | Example | Ex. |
| | | 1 | 2 | 1 |
| Evaluation | Whether to maintain | O | O | X |
| at −10° C. | shape | | | |
| | A value (mm) | 10.395 | 10.395 | 9.588 |
| | B value (mm) | 10.395 | 10.395 | 9.623 |
| | Strain rate | 0% | 0% | 0.365% |
| Evaluation | Whether to maintain | O | O | X |
| at 25° C. | shape | | | |
| | A value(mm) | 10.395 | 10.395 | 9.588 |
| | B value (mm) | 10.613 | 10.618 | 10.033 |
| | Strain rate | 2.097% | 2.145% | 4.641% |
| Evaluation | Whether to maintain | O | O | X |
| at 40° C. | shape | | | |
| | A value (mm) | 10.395 | 10.395 | 9.588 |
| | B value (mm) | 10.643 | 10.818 | 10.515 |
| | Strain rate | 2.386% | 4.069% | 9.668% |
| Evaluation | Whether to maintain | O | O | X |
| at 60° C. | shape | | | |
| | A value (mm) | 10.395 | 10.395 | 9.588 |
| | B value (mm) | 10.825 | 11.035 | 11.167 |
| | Strain rate | 4.137% | 6.157% | 16.469% |

“Whether to maintain shape” means a shape that the center of the nail sticker is upwardly curved when the nail sticker is disposed on the flat floor and left for 24 hours (whether to maintain a state that the center of the lower surface of the nail sticker is spaced apart from the floor). That is, it means that whether the curved shape is maintained during the process of being supplied to the consumer. (if it is maintained, denoted by O and if it is not maintained, denoted by X)

The strain rate was calculated by the following Equation 1.

$$Strain rate = [ ( B - A ) / A ] \times 100 \qquad [ Equation 1 ]$$

In Equation 1 and Table 1, A value is a maximum value of a width of the nail sticker measured immediately after placing the nail sticker on the flat floor. The B value is a maximum value of the width of the nail sticker measured after the nail sticker was left for one hour while being placed on the flat floor.

### EXPLANATION OF REFERENCE NUMERALS AND SYMBOLS

100: Nail sticker
110: Soft layer
120: Base layer
130: Coating layer
200: Support structure
210: Support unit
300: Nail sticker set

1. A nail sticker which is curable by ultraviolet ray, wherein a lower surface of the nail sticker before being cured by the ultraviolet ray includes a curved surface that the center of the nail sticker is upwardly curved.

2. The nail sticker according to claim 1, wherein when the nail sticker is disposed on a flat floor such that the lower surface of the nail sticker before being cured by the ultraviolet ray faces the flat floor, the center of the nail sticker is spaced apart from the floor.

3. The nail sticker according to claim 1, wherein when the nail sticker is disposed on the flat floor so that the lower surface of the nail sticker before being cured by the ultraviolet ray faces the flat floor, a strain rate according to Equation 1 is 4% or lower in the atmosphere of a temperature of 25° C.
$$Strain rate = [ ( B - A ) / A ] \times 100 \qquad [ Equation 1 ]$$
in Equation 1, A refers to a maximum value of a width of the nail sticker measured immediately after placing the nail sticker on the flat floor and B refers to a maximum value of a width of the nail sticker measured one hour after placing the nail sticker on the flat floor.

4. The nail sticker according to claim 1, wherein when the nail sticker is disposed on the flat floor so that the lower surface of the nail sticker before being cured by the ultraviolet ray faces the flat floor, a strain rate according to Equation 1 is 2.10% or lower in the atmosphere of a temperature of 25° C.
$$Strain rate = [ ( B - A ) / A ] \times 100 \qquad [ Equation 1 ]$$
in Equation 1, A refers to a maximum value of a width of the nail sticker measured immediately after placing the nail sticker on the flat floor and B refers to a maximum value of a width of the nail sticker measured one hour after placing the nail sticker on the flat floor.

5. The nail sticker according to claim 1, wherein when the nail sticker is disposed on the flat floor so that the lower surface of the nail sticker before being cured by the ultraviolet ray faces the flat floor, a strain rate according to Equation 1 is 0.2% or lower in the atmosphere of −10° C.
$$Strain rate = [ ( B - A ) / A ] \times 100 \qquad [ Equation 1 ]$$
in Equation 1, A refers to a maximum value of a width of the nail sticker measured immediately after placing the nail sticker on the flat floor and B refers to a maximum value of a width of the nail sticker measured one hour after placing the nail sticker on the flat floor.

6. The nail sticker according to claim 1, wherein when the nail sticker is disposed on the flat floor so that the lower surface of the nail sticker before being cured by the ultraviolet ray faces the flat floor, a strain rate according to Equation 1 is 6% or lower in the atmosphere of 40° C.
$$Strain rate = [ ( B - A ) / A ] \times 100 \qquad [ Equation 1 ]$$
in Equation 1, A refers to a maximum value of a width of the nail sticker measured immediately after placing the nail sticker on the flat floor and B refers to a maximum value of a width of the nail sticker measured one hour after placing the nail sticker on the flat floor.

7. The nail sticker according to claim 1, wherein the nail sticker includes at least one or more coating layers, and the coating layer includes an UV curable raw material.

8. The nail sticker according to claim 1, wherein the nail sticker includes a base layer, and the base layer includes an adhesive layer.

9. The nail sticker according to claim 1, wherein the adhesive layer is located below the nail sticker to configure at least a part of the lower surface of the nail sticker.

10. The nail sticker according to claim 1, wherein when the nail sticker before being cured by the ultraviolet ray is placed on the flat floor and the upper surface of the nail sticker is pushed with a force of 10 N using PUSH GAGE equipment of IMADA Inc., the lower surface of the center of the nail sticker touches the floor.

11. The nail sticker according to claim 1, wherein when the nail sticker is placed on the flat floor such that the lower surface of the nail sticker before being cured by the ultraviolet ray faces the flat floor, at least a part of an edge of the nail sticker is in contact with the flat floor.

12. The nail sticker according to claim 1, wherein the nail sticker includes a soft layer, the soft layer includes a resin for the soft layer, and the resin for the soft layer includes at least one of cellulose acetate butyrate and cellulose acetate propionate.

13. A manufacturing method of a nail sticker, comprising:
a first step of placing a UV curable preliminary nail sticker on a support unit included in a support structure; and
a second step of attaching a lower surface of the preliminary nail sticker to an upper surface of the support unit by applying a pressure to an upper surface of the preliminary nail sticker,
wherein the support unit has a curved surface which is upwardly convex and a lower surface of the nail sticker before being cured by the ultraviolet ray includes a curved surface that a center of the nail sticker is upwardly curved.

14. The manufacturing method of nail sticker according to claim 13, wherein in the first step, before placing the preliminary nail sticker on the support unit, when the nail sticker is placed on the flat floor such that the lower surface of the preliminary nail sticker before being cured by the ultraviolet ray faces the flat floor, the lower surface of the preliminary nail sticker is flat.

15. The manufacturing method of nail sticker according to claim 13, further comprising:
after the second step,
a third step of applying heat to the preliminary nail sticker adhered on the support unit.

16. The manufacturing method of nail sticker according to claim 15, wherein a temperature of the heat applied in the third step is 30° C. to 70° C.

17. A nail sticker set, comprising:
a support structure including a support unit; and
a nail sticker attached on an upper surface of the support unit,
wherein the upper surface of the support unit includes a curved surface that the center of the sticker is upwardly curved, the nail sticker is curable by ultraviolet ray, and a lower surface of the nail sticker before being cured by the ultraviolet ray includes a curved surface that the center of the nail sticker is upwardly curved.

18. The nail sticker set according to claim 17, wherein 50% or more of the lower surface of the nail sticker is in contact with the upper surface of the support unit.

19. The nail sticker set according to claim 17, wherein when the nail sticker is removed from the support unit and the nail sticker is disposed on the flat floor such that the lower surface of the nail sticker before being cured by the ultraviolet ray faces the flat floor, the center of the nail sticker is spaced apart from the floor.

20. The nail sticker set according to claim 17, wherein when the nail sticker is removed from the support unit and the nail sticker is disposed on the flat floor such that the lower surface of the nail sticker before being cured by the ultraviolet ray faces the flat floor, a strain rate according to Equation 1 is 4% or lower in the atmosphere of a temperature of 25° C.
$$Strain rate = [ ( B - A ) / A ] \times 100 \qquad [ Equation 1 ]$$
in Equation 1, A refers to a maximum value of a width of the nail sticker measured immediately after placing the nail sticker on the flat floor and B refers to a maximum value of a width of the nail sticker measured one hour after placing the nail sticker on the flat floor.

21. The nail sticker set according to claim 17, wherein a material of the upper surface of the support unit includes at least any one selected from the group consisting of polyethylene, polypropylene, and silicon.

22. The nail sticker set according to claim 17, wherein the support structure includes two or more support units and the nail sticker set includes two or more nail stickers.
